(19) United States
(12) Patent Application Publication
(10) Pub. No.: US 2023/0207844 A1
(43) Pub. Date: Jun. 29, 2023

(54) VANADIUM BATTERY SOC BALANCE SYSTEM STRUCTURE AND CONTROL METHOD THEREOF

(71) Applicant: VRB ENERGY OPERATIONS (BEIJING) CO. LTD., Beijing (CN)

(72) Inventors: Bo HU, Beijing (CN); Mianyan HUANG, Beijing (CN); Chen ZHANG, Beijing (CN); Shuang XU, Beijing (CN)

(21) Appl. No.: 18/145,778

(22) Filed: Dec. 22, 2022

(30) Foreign Application Priority Data
Dec. 23, 2021 (CN) 202111595052.4A

(51) Int. Cl. H01M 8/04082; H01M 8/18; H01M 8/04537; H01M 8/04746

(52) U.S. Cl. CPC H01M 8/04201; H01M 8/188; H01M 8/04619; H01M 8/04746

(57) ABSTRACT

Systems and methods for vanadium battery state-of-charge balance are disclosed. An example system includes a state-of-charge detection module, a state detection module, a control module and a plurality of vanadium battery modules in series. Each vanadium battery module includes positive and negative electrode electrolyte tanks, and a balance pipeline with a controllable switch between the positive and negative electrode electrolyte tanks of any two vanadium battery modules. The state-of-charge detection module detects and outputs the state-of-charge value of each vanadium battery module. The state detection module detects and outputs the charge and discharge states of the vanadium battery modules. The control module controls the vanadium battery modules to stop charging and discharging when the state-of-charge difference of any two vanadium battery modules is larger than a predetermined value, or controls the on-off state of the corresponding controllable switch according to the charging and discharging state and the state-of-charge difference value.

### RELATED APPLICATIONS

This application claims priority to and the benefit of Chinese Patent Application No. 202111595052.4, filed on Dec. 23, 2021, the disclosure of which is expressly incorporated herein by reference in its entirety

### TECHNICAL FIELD

This application relates to the field of vanadium batteries, in particular to a vanadium battery state of charge (SOC) balance system structure and control method thereof.

### BACKGROUND

The vanadium battery is a storage battery and can store energy by utilizing different chemical potential energies of vanadium ions in different oxidation states. The vanadium battery has the advantages of high charging and discharging efficiency, recyclable electrolyte and the like.

It can be understood that, in order to improve the service life of the vanadium redox battery, when designing a vanadium redox battery system, it is generally required that the SOC of the vanadium redox battery reaches a state of continuous equilibrium as much as possible. Generally, a plurality of electric piles can be connected between a positive electrolyte tank and a negative electrolyte tank, all the electric piles are connected in series to improve the battery capacity, but the current flowing into the electric piles can cause electrochemical damage. Therefore, a plurality of groups of electric piles can be arranged in parallel, and one positive electrolyte tank and one negative electrolyte tank are configured for each group of electric piles, so that the influence of the current flowing into the electric piles on the electrochemical reaction can be reduced by disconnecting the liquid circuit, but the unbalance of the SOC can also be caused.

### SUMMARY

In order to simultaneously relieve the influence of the SOC imbalance of the vanadium battery and the generated electrochemical damage on the service life of the vanadium battery, the application provides a system structure for balancing the SOC of the vanadium battery and a control method thereof.

In a first aspect, the application provides a vanadium redox battery SOC balance system structure, which adopts the following technical scheme:

a vanadium battery SOC balance system structure includes an SOC detection module, a state detection module, a control module and a plurality of vanadium battery modules which are connected in series;

each vanadium battery module includes a positive electrolyte tank and a negative electrolyte tank, balance pipelines for flowing of electrolyte are arranged between the positive electrolyte tanks, between the negative electrolyte tanks and between the positive electrolyte tanks and the negative electrolyte tanks of any two vanadium battery modules, and each balance pipeline is provided with a controllable switch;

the SOC detection module is used for detecting and outputting the SOC value of each vanadium battery module;

the state detection module is used for detecting and outputting the charge and discharge states of the vanadium battery modules;

the control module is respectively connected with the SOC detection module and the state detection module, and is used for controlling the plurality of vanadium battery modules to stop charging and discharging when the SOC difference value of any two vanadium battery modules is larger than a preset value, and is also used for controlling the on-off state of the corresponding controllable switch according to the charging and discharging state and the SOC difference value when the SOC difference value of any two vanadium battery modules is smaller than the preset value.

Through adopting above-mentioned technical scheme, when the SOC of two arbitrary vanadium battery modules appears unbalance, if the SOC difference is too big, then the automatic shutdown charge-discharge to in inspect a plurality of vanadium battery modules, when the SOC difference is less, can open through control controllable switch, make the liquid level between two positive pole electrolyte tanks and between two negative pole electrolyte tanks of two vanadium battery modules reach balanced, so that the SOC value of two vanadium battery modules reaches balanced. Meanwhile, when the controllable switch is turned on, the balance pipelines between the anode electrolyte tanks, the cathode electrolyte tanks and between the anode electrolyte tanks and the cathode electrolyte tanks of the two vanadium battery modules can also reduce the current flowing into the galvanic pile, so that the influence of the SOC imbalance of the vanadium battery and the current flowing into the galvanic pile on the service life of the vanadium battery is relieved simultaneously.

Optionally, each vanadium redox battery module further includes a plurality of parallel electric stacks, and the plurality of parallel electric stacks are sequentially connected in series.

Through adopting above-mentioned technical scheme, can not only improve power but also can improve battery capacity.

Optionally, the resistance value of the balance pipeline is not less than the resistance threshold value.

Optionally, the control module includes a processing unit and a control unit;

the processing unit is connected with the SOC detection module and is used for calculating and outputting the SOC difference value of any two vanadium battery modules;

the control unit is respectively connected with the state detection module and the processing unit, and is used for controlling the vanadium battery modules to stop charging and discharging when the SOC difference value of any two vanadium battery modules is larger than a preset value, and is also used for controlling the on-off state of the corresponding controllable switch according to the charging and discharging state and the SOC difference value when the SOC difference value of any two vanadium battery modules is smaller than the preset value.

Optionally, the control unit is further configured to: obtaining the SOC value of each vanadium battery module;

calculating an SOC difference value according to the SOC values of any two vanadium battery modules;

judging whether the SOC difference exceeds a preset value, if so, outputting a stop signal, wherein the stop signal is used for controlling all vanadium battery modules to stop charging and discharging, and if not, acquiring a charging and discharging state;

when the vanadium battery modules are in a charging state, judging whether the SOC values of the vanadium battery modules exceed a dangerous threshold value, if so, outputting a closing signal, if not, judging whether the SOC difference value of every two connected vanadium battery modules is smaller than a difference threshold value, if so, outputting a closing signal, and if not, outputting an opening signal;

when the plurality of vanadium battery modules are in a discharging state, judging whether the SOC difference value of any two vanadium battery modules is smaller than a difference threshold value, if so, outputting a closing signal, and if not, outputting a starting signal.

By adopting the technical scheme, when the SOC value of the vanadium battery module reaches the dangerous threshold value, the electrochemical damage can be caused by starting the controllable switch, and the service life of the vanadium battery module is further shortened, so that when the SOC value exceeds the dangerous threshold value in the charging process, the state of the controllable switch needs to be switched to the closed state.

Optionally, the SOC detection module, the state detection module, and the control module are energy management system (EMS) controllers.

Optionally, every anodal electrolyte tank and every negative pole electrolyte tank all are provided with the trunk line respectively, and the tip that anodal electrolyte tank or negative pole electrolyte tank were kept away from to every trunk line is provided with a plurality of branch road pipelines respectively, and every branch road pipeline all is connected with a pile of organizing together, is provided with first circulating pump on the trunk line of being connected with every anodal electrolyte tank, is provided with the second circulating pump on the trunk line of being connected with every negative pole electrolyte tank.

Through adopting above-mentioned technical scheme, the circulating pump can be with anodal electrolyte and negative pole electrolyte pump sending to each pile.

In a second aspect, the application provides a control method for a vanadium redox battery SOC balance system structure, which adopts the following technical scheme:

a control method of a vanadium battery SOC balance system structure includes:

acquiring the SOC value of each vanadium battery module;

calculating an SOC difference value according to the SOC values of any two vanadium battery modules;

judging whether the SOC difference exceeds a preset value, if so, outputting a stop signal, wherein the stop signal is used for controlling all vanadium battery modules to stop charging and discharging, and if not, acquiring a charging and discharging state;

when the vanadium battery modules are in a charging state, judging whether the SOC values of the vanadium battery modules exceed a dangerous threshold value, if so, outputting a closing signal, if not, judging whether the SOC difference value of any two vanadium battery modules is smaller than a difference threshold value, if so, outputting a closing signal, and if not, outputting an opening signal;

when the plurality of vanadium battery modules are in a discharging state, judging whether the SOC difference value of any two vanadium battery modules is smaller than a difference threshold value, if so, outputting a closing signal, and if not, outputting a starting signal.

Optionally, the preset value is any value within 3% to 15%, the danger threshold value is any value within 30% to 80%, and the difference threshold value is 2%.

In summary, the present application includes at least one of the following beneficial technical effects:

1. the on-off state of a controllable switch on a corresponding balance pipeline can be controlled according to the current charge and discharge state of all vanadium battery modules, the SOC values of any two vanadium battery modules and the difference value of the SOC values, so that the liquid levels between two anode electrolyte tanks, two cathode electrolyte tanks and between the anode electrolyte tank and the cathode electrolyte tank of the two vanadium battery modules are adjusted when the SOC difference value is smaller, further the SOC value balance is achieved, meanwhile, when the controllable switch is started, the balance pipelines between the anode electrolyte tanks, the cathode electrolyte tanks and between the anode electrolyte tank and the cathode electrolyte tank of the two vanadium battery modules can also reduce the current flowing into the pile, and further the influence of the SOC imbalance of the vanadium battery and the current flowing into the pile on the service life of the vanadium battery is relieved;

2. when the SOC value of the vanadium battery module reaches a dangerous threshold value, the electrochemical damage can be caused by starting the controllable switch, and the service life of the vanadium battery module is further shortened.

Additional aspects and advantages will be apparent from the following detailed description of preferred embodiments, which proceeds with reference to the accompanying drawings.

### BRIEF DESCRIPTION OF THE DRAWINGS

FIG. 1 is a system schematic diagram of a vanadium redox battery SOC balance system structure according to an embodiment of the present application.

FIG. 2 is a schematic circuit diagram of a structure of a vanadium redox battery SOC balancing system according to an embodiment of the present application.

### DETAILED DESCRIPTION OF PREFERRED EMBODIMENTS

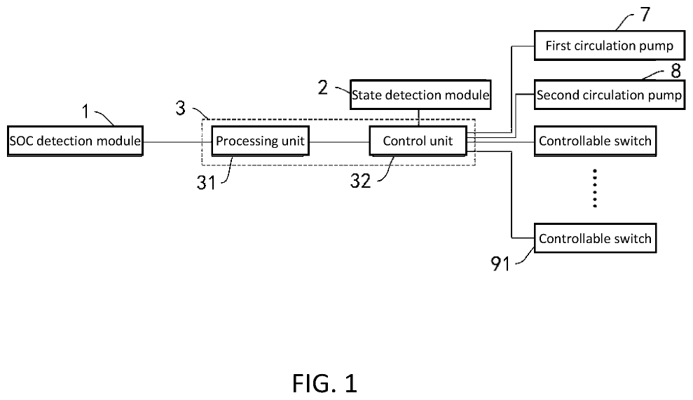

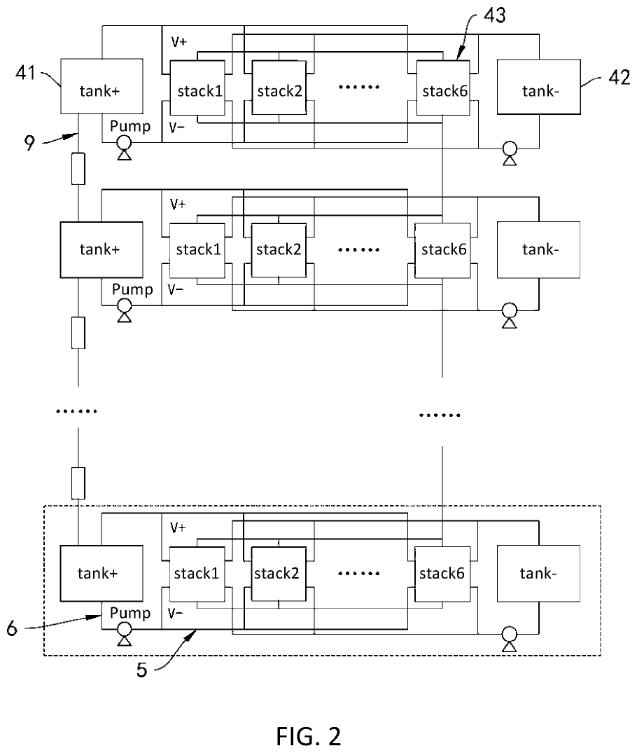

In order to make the objects, technical solutions and advantages of the present application more apparent, the present application is further described in detail below with reference to FIGS. 1-2 and the embodiments. It should be understood that the specific embodiments described herein are merely illustrative of the present application and are not intended to limit the present application.

The embodiment of the application discloses vanadium cell SOC balanced system structure can alleviate the influence of the unbalanced SOC of vanadium cell and the current that flows into the galvanic pile to vanadium cell life simultaneously.

Referring to FIGS. 1 and 2, the vanadium redox battery SOC balance system structure includes an SOC detection module 1, a state detection module 2, a control module 3, and a plurality of vanadium redox battery modules 4 connected in series.

Referring to FIG. 2, specifically, each vanadium battery module 4 includes a positive electrolyte tank 41 and a negative electrolyte tank 42, and a plurality of parallel stacks 43. Wherein, the positive electrode electrolyte tank 41 and the negative electrode electrolyte tank 42 in the vanadium battery module 4 are respectively communicated with the positive electrode and the negative electrode of each electric pile 43 through the branch pipeline 5. Specifically, the positive electrode electrolyte tank 41 and the negative electrode electrolyte tank 42 are provided with a main pipe 6, respectively, and the positive electrode electrolyte tank 41 and the negative electrode electrolyte tank 42 are communicated with the corresponding main pipes 6, respectively. Each end portion of the main pipe 6 away from the positive electrode electrolyte tank 41 or the negative electrode electrolyte tank 42 is provided with a plurality of branch pipes 5, and is respectively communicated with the corresponding plurality of branch pipes 5. Each branch pipe 5 communicates with the positive electrode and the negative electrode of each stack 43 to flow the electrolytes in the positive electrolyte tank 41 and the negative electrolyte tank 42. A first circulating pump 7 is further arranged on the main pipeline 6 communicated with the anode electrolyte tank 41, and a second circulating pump 8 is further arranged on the main pipeline 6 communicated with the cathode electrolyte tank 42, so that the anode electrolyte can circulate between the anode electrolyte tank 41 and each electric pile 43, and similarly, the cathode electrolyte can circulate between the cathode electrolyte tank 42 and each electric pile 43.

In order to make the battery capacity formed by all vanadium battery modules 4 as large as possible, in the present application, a plurality of vanadium battery modules 4 are connected in series in sequence, wherein a plurality of parallel electric stacks 43 in each vanadium battery module 4 are connected in series in sequence.

Furthermore, the balance pipelines 9 are arranged between the two positive electrolyte tanks 41, between the two negative electrolyte tanks 42 and between the positive electrolyte tank 41 and the negative electrolyte tank 42 in any two vanadium battery modules 4, so that the two positive electrolyte tanks 41 of the two vanadium battery modules 4 are communicated, the two negative electrolyte tanks 42 are communicated, and the positive electrolyte tank 41 and the negative electrolyte tank 42 in the same vanadium battery module 4 are communicated. Meanwhile, the balance pipeline 9 is further provided with a controllable switch 91, so that when the SOC difference value of the two vanadium battery modules 4 is large, the controllable switch 91 is controlled to be turned on to enable the liquid levels of the two anode electrolyte tanks 41 and the liquid levels of the two cathode electrolyte tanks 42 to be consistent, and further eliminate the SOC difference value between the two vanadium battery modules 4. Of course, when the liquid level difference between the positive electrolyte tank 41 and the negative electrolyte tank 42 is large, the controllable switch 91 may be controlled to be turned on to make the liquid levels in the positive electrolyte tank 41 and the negative electrolyte tank 42 consistent, so as to reduce the more serious SOC imbalance caused by the vanadium redox battery module 4 in the charging or discharging process. Among them, the controllable switch 91 is preferably a solenoid valve.

It is worth noting that each vanadium battery module 4 includes a plurality of galvanic stacks 43 connected in parallel, the voltage value across each galvanic stack 43 being U. Since electrochemical destruction may be caused by excessive current flowing through the plurality of parallel stacks 43, the maximum value of the current flowing through the plurality of parallel stacks 43 may not exceed the maximum tolerable current I. For this reason, this application is through increasing the length of trunk line 6 to increase the resistance value that vanadium battery module 4 inserts, and then reduce the electric current that flows through parallelly connected pile 43.

It can be understood that when the controllable switch 91 is in the on state, the balancing pipe 9 not only can balance the liquid levels of the two positive electrolyte tanks 41 and the two negative electrolyte tanks 42 in the vanadium battery module 4, but also can be made of a conductive material, and can be used as a resistor to reduce the current flowing through the parallel electric stacks 43. In order for the current flowing through the parallel stack 43 not to exceed the maximum tolerable current I, the resistance value of the balancing conduit 9 should not fall below the resistance threshold value R, i.e. the resistance threshold value R=U/I. Specifically, the resistance value of the balance duct 9 may be increased by increasing the length or thickness of the balance duct 9, or the like.

Referring to FIGS. 1 and 2, further, the SOC detection module 1 is configured to detect and output an SOC value of each vanadium battery module 4. Since the SOC value of the vanadium battery module 4 cannot be directly detected, the SOC detection module 1 actually detects the open-circuit voltage OCV between the two poles of each vanadium battery module 4, and converts the open-circuit voltage into a corresponding SOC value.

The state detection module 2 is used for detecting and outputting the charge and discharge states of all the vanadium battery modules 4.

The control module 3 is respectively connected with the SOC detection module 1 and the state detection module 2, and is used for controlling all the vanadium battery modules 4 to stop charging and discharging when the SOC difference values of any two vanadium battery modules 4 are larger than a preset value, and is also used for controlling the on-off state of the corresponding controllable switch 91 according to the SOC difference values of all the vanadium battery modules 4 when the SOC difference values of any two vanadium battery modules are smaller than the preset value.

Specifically, the control module 3 includes a processing unit 31 and a control unit 32.

The processing unit 31 is connected to the SOC detection module 1, and is configured to receive the SOC value of each vanadium battery module 4, calculate and output an SOC difference value between any two vanadium battery modules 4. Specifically, a subtraction operator chip can be used, and since the technology thereof belongs to the conventional technical means of those skilled in the related art, it will not be described herein too much.

The control unit 32 is respectively connected to the state detection module 2 and the processing unit 31, and is configured to control the plurality of vanadium battery modules 4 to stop charging and discharging when the SOC difference value of any two vanadium battery modules 4 is greater than a preset value, and also configured to control the on/off state of the corresponding controllable switch 91 according to the charging and discharging state SOC difference value of all vanadium batteries when the SOC difference value of any two vanadium battery modules 4 is less than the preset value.

When the control unit 32 controls the on-off state of the controllable switch 91 to reach the SOC value of the balanced vanadium battery module 4, the specific process is as follows:

first, the SOC difference values between all of any two vanadium battery modules 4 calculated by the processing unit 31 are acquired.

And then, judging whether each SOC difference value exceeds a preset value, if one SOC difference value exceeds the preset value, outputting a stop signal to control all the vanadium battery modules 4 to stop charging and discharging so as to facilitate detection, and further reducing the probability of faults of all the vanadium battery modules 4. On the contrary, if all the SOC difference values do not exceed the preset value, the current charge and discharge states of all the vanadium battery modules 4 detected by the state detection module 2 are continuously obtained.

When all the vanadium battery modules 4 are in a discharging state, whether all the SOC difference values are higher than the difference value threshold value is judged one by one, if yes, a starting signal is output to control a controllable switch 91 on a balance pipeline 9 between the two vanadium battery modules 4 corresponding to the SOC difference value to be started, and the SOC balance of the two vanadium battery modules 4 is achieved by balancing the liquid level between two anode electrolyte tanks 41 and the liquid level between two cathode electrolyte tanks 42 of the vanadium battery modules 4 corresponding to the SOC difference value. On the contrary, if the SOC difference is not higher than the difference threshold, it indicates that the SOC difference of the two vanadium battery modules 4 corresponding to the SOC difference is within the allowed range, and it is no longer necessary to balance the liquid level between the positive electrolyte tank 41 and the liquid level between the negative electrolyte tank 42 by opening the balancing conduit 9, that is, the control unit 32 outputs a closing signal at this time to control the controllable switch 91 on the balancing conduit 9 between the two vanadium battery modules 4 corresponding to the SOC difference to be closed.

Similarly, when all the vanadium battery modules 4 are in the charging state, whether all the SOC difference values are higher than the difference threshold value is determined one by one, if so, an on signal is output, otherwise, if the SOC difference values are not higher than the difference threshold value, an off signal is output.

It should be noted that, in the process that the control unit 32 controls on and off of all the controllable switches 91, when all the controllable switches 91 are in the off state, the liquid path between any two vanadium battery modules 4 is in the off state, and at this time, power consumption of all the pipelines in all the vanadium battery modules 4 is the minimum. Once the controllable switches 91 start to be switched to the on state, the number of the balance pipelines 9 connected between the two vanadium battery modules 4 is gradually increased along with the gradual increase of the number of the controllable switches 91, so that the power consumption of all the pipelines is increased, and the power consumption of all the pipelines reaches the maximum value until all the controllable switches 91 are in the on state. Therefore, when all the vanadium battery modules 4 are in the charging process and the controllable switches 91 are in the on state, the power consumption of all the pipelines is increased to easily cause electrochemical damage, and therefore when all the vanadium battery modules 4 are in the charging state, the corresponding controllable switches 91 need to be controlled to be turned off when the SOC value of any one vanadium battery module 4 reaches the danger threshold.

In other words, when all the vanadium battery modules 4 are in the charging state, it is first necessary to determine whether the SOC values of the vanadium battery modules 4 exceed the danger threshold one by one, and if the SOC values of the vanadium battery modules 4 exceed the danger threshold, the control unit 32 outputs the shutdown information. On the contrary, whether the SOC difference value of any two vanadium battery modules 4 is smaller than the difference threshold value is continuously judged.

The above mentioned preset value can be any value within 3% to 15%, in the present application, preferably 5%; the above-mentioned danger threshold may be any value within 30% to 80%, and in the present application, is preferably 70%; the above-mentioned difference threshold is preferably 2% in the present application.

In addition, the SOC detection module 1, the state detection module 2, and the control module 3 of the present application preferably employ an EMS controller.

The implementation principle of the SOC balance system structure of the vanadium redox battery and the control method thereof in the embodiment of the application is as follows: by arranging the balance pipelines 9 between any two vanadium battery modules 4 and arranging the controllable switch 91 on each balance pipeline 9, when the controllable switch 91 is controlled to be turned on according to the charging and discharging state and the SOC difference value, the liquid level between two anode electrolyte tanks 41 and the liquid level between two cathode electrolyte tanks 42 of the vanadium battery modules 4 corresponding to the SOC difference value and the liquid levels between the anode electrolyte tanks 41 and the cathode electrolyte tanks 42 are balanced, so that the SOC balance is achieved. When controllable switch 91 is in the on-state, the vanadium redox battery SOC balanced structure of this application can balance SOC, when controllable switch 91 is in the off-state, can reduce the system loss, and then improves the life of whole vanadium redox battery from two aspects.

The foregoing is a preferred embodiment of the present application and is not intended to limit the scope of the application in any way, and any features disclosed in this specification (including the abstract and drawings) may be replaced by alternative features serving equivalent or similar purposes, unless expressly stated otherwise. That is, unless expressly stated otherwise, each feature is only an example of a generic series of equivalent or similar features.

It will be obvious to those having skill in the art that many changes may be made to the details of the above-described embodiments without departing from the underlying principles of the invention. The scope of the present invention should, therefore, be determined only by the following claims.

What is claimed is:

1. A vanadium battery state of charge (SOC) balancing system comprising: an SOC detection module, a state detection module, a control module and a plurality of vanadium battery modules connected in series,
wherein each vanadium battery module of the plurality of vanadium battery modules comprises:
a positive electrode electrolyte tank and a negative electrode electrolyte tank,
balance pipelines configured to allow an electrolyte to flow, each balance pipeline with a controllable switch, provided between either the positive electrode electrolyte tanks of any two vanadium battery modules of the plurality of vanadium battery modules, between the negative electrode electrolyte tanks thereof, or between the positive electrode electrolyte tanks and the negative electrode electrolyte tanks thereof,
wherein the SOC detection module is configured to detect and output an SOC value of each vanadium battery module of the plurality of vanadium battery modules,
wherein the state detection module is configured to detect and output charging and discharging states of the plurality of vanadium battery modules, and
wherein the control module is separately connected to the SOC detection module and the state detection module, the control module is configured to control the plurality of vanadium battery modules to stop charging and discharging when an SOC difference between any two vanadium battery modules of the plurality of vanadium battery modules is greater than a predetermined value, and is further configured to control on and off states of corresponding controllable switches according to the charging and discharging states and the SOC differences when the SOC difference between any two vanadium battery modules of the plurality of vanadium battery modules is less than the predetermined value.

2. The vanadium battery SOC balancing system structure according to claim 1, wherein each vanadium battery module of the plurality of vanadium battery modules further comprises a plurality of parallel cell stacks connected in series.

3. The vanadium battery SOC balancing system structure according to claim 2, wherein the balance pipeline has a resistance value not less than a resistance threshold value.

4. The vanadium battery SOC balancing system structure according to claim 2, wherein the control module comprises a processing unit and a control unit,
wherein the processing unit is connected to the SOC detection module, and configured to calculate and output the SOC difference between any two vanadium battery modules of the plurality of vanadium battery modules, and
wherein the control unit is separately connected to the state detection module and the processing unit, and is configured to control the plurality of vanadium battery modules to stop charging and discharging when the SOC difference between any two vanadium battery modules of the plurality of vanadium battery modules is greater than the predetermined value, and is further configured to control on and off states of corresponding controllable switches according to the charging and discharging states and the SOC differences when the SOC difference between any two vanadium battery modules of the plurality of vanadium battery modules is less than the predetermined value.

5. The vanadium battery SOC balancing system structure according to claim 4, wherein the control unit is further configured to:
obtain the SOC value of each vanadium battery module of the plurality of vanadium battery modules;
calculate the SOC difference according to the SOC values of any two vanadium battery modules of the plurality of vanadium battery modules;
determine whether the SOC difference exceeds the predetermined value, and if so, output a stop signal, the stop signal being configured to control all vanadium battery modules to stop charging and discharging, and if not, obtain charging and discharging states;
when the plurality of vanadium battery modules are in the charging state, determine whether the SOC values of the plurality of vanadium battery modules exceed a danger threshold, if so, output an off signal, and if not, determine whether the SOC difference between every two connected vanadium battery modules of the plurality of vanadium battery modules is less than a difference threshold, if so, output the off signal, and if not, output an on signal; and
when the plurality of vanadium battery modules are in the discharging state, determine whether the SOC difference between any two vanadium battery modules of the plurality of vanadium battery modules is less than the difference threshold; if so, output the off signal, and if not, output the on signal.

6. The vanadium battery SOC balancing system structure according to claim 5, wherein the SOC detection module, the state detection module and the control module are energy management system (EMS) controllers.

7. The vanadium battery SOC balancing system structure according to claim 2, wherein each positive electrode electrolyte tank and each negative electrode electrolyte tank are provided with main pipelines, respectively, an end of each main pipeline away from the positive electrode electrolyte tank or the negative electrode electrolyte tank is provided with a plurality of branch pipelines, each branch pipeline is connected to cell stacks of the same group, the main pipeline connected to each positive electrode electrolyte tank is provided with a first circulating pump, and the main pipeline connected to each negative electrode electrolyte tank is provided with a second circulating pump.

8. A method for controlling a vanadium battery SOC balancing system structure, the method comprising:
obtaining an SOC value of each vanadium battery module;
calculating an SOC difference according to the SOC values of any two vanadium battery modules;
determining whether the SOC difference exceeds a predetermined value, and if so, outputting a stop signal, the stop signal being configured to control all vanadium battery modules to stop charging and discharging, and if not, obtaining charging and discharging states;
when a plurality of vanadium battery modules are in the charging state, determining whether the SOC values of the plurality of vanadium battery modules exceed a danger threshold, if so, outputting an off signal, and if not, determining whether the SOC difference between any two vanadium battery modules of the plurality of vanadium battery modules is less than a difference threshold, if so, outputting the off signal, and if not, outputting an on signal; and
when the plurality of vanadium battery modules are in the discharging state, determining whether the SOC difference between any two vanadium battery modules of the plurality of vanadium battery modules is less than the difference threshold; if so, outputting the off signal, and if not, outputting the on signal.

9. The method for controlling the vanadium battery SOC balancing system structure according to claim 8, wherein the predetermined value is any value within 3% to 15%, the danger threshold is any value within 30% to 80%, and the difference threshold is 2%.
